(19) United States
(12) Patent Application Publication
(10) Pub. No.: US 2001/0026657 A1
(43) Pub. Date: Oct. 4, 2001

(54) Coupling device

(76) Inventors: Hans Kodeda, Adelkofen (DE); Susanne Krattenmacher, Muenchen (DE)

Correspondence Address: Ivor R. Elrifi, Esq., MINTZ, LEVIN, COHN, FERRIS., GLOVSKY and POPEO, P.C., One Financial Center, Boston, MA, 02111, US

(21) Appl. No.: 09/783,424

(22) Filed: Feb. 14, 2001

(30) Foreign Application Priority Data
Feb. 15, 2000 (DE) 100 06 614.3

(51) Int. Cl. G02B 6/26; G02B 6/36

(52) U.S. Cl. 385/31; 385/76

(57) ABSTRACT

The present invention relates to a coupling device for feeding a laser beam 66 into at least one optical fiber 12, in particular an optical wave-guide, including a fiber coupler 18 for accommodating said fiber 12, and an optical device 94 for deflecting, adjusting and directing said laser beam 66 towards one end 14 of said fiber 12, with said fiber coupler 18 being provided within said coupling device 10 such that it can be slid vertically and horizontally in the x-y directions, and with said optical device 94 including an optical bank 96 with at least two optical components 58, 62, said optical bank 96 being connected to said fiber coupler 18 via a coupling element 32 provided at the end of said optical bank 96 which is opposite the entry site of said laser beam 66.

### FIELD OF THE INVENTION

The present invention relates to a coupling device for feeding a laser beam into at least one optical fiber, in particular an optical wave-guide, comprising a fiber coupler for accommodating said fiber as well as an optical device for deflecting the laser beam and directing it towards one fiber end.

### BACKGROUND OF THE INVENTION AND PRIOR ART

Coupling devices of this type are known from the prior art. They especially serve to transfer a relatively large diameter laser beam into a smaller diameter optical fiber without incurring major energy losses. In order to avoid this, the respective ends of the optical fibers have been surface-ground. However, this grinding process always leaves some impurities and minor scratches on the surface of said optical fiber end, causing an absorption of laser energy. For this reason, it is absolutely vital to focus the laser beam optimally on the optical fiber surface.

U.S. Pat. No. 4,732,448 discloses a coupling device in which the end of the optical fiber into which the laser light is to be fed takes the form of a semispherical lens. However, said lens may also be provided separately in front of said fiber end. Spaced from said first lens is a second lens focusing the incoming laser beam on a certain focal point. In this case, the distance between said first and second lenses is longer than the focal distance of said second lens. This makes the focused laser light appear to come from a point-like source, and it enters the fiber via said first lens.

Other generic coupling devices are also known from the prior art. However, these include a plurality of optical components which, on the one hand, are problematic where maintenance is concerned, and are difficult to adjust on the other hand. The resulting maladjustment, caused especially also by temperature fluctuations or dirt accumulation on or in the optical components, will cause the latter to become dull or tarnished in operation, thus increasing the laser energy losses. Ultimately, this may even result in the destruction of the optical fiber and/or the fiber end.

### SUMMARY OF THE INVENTION

It is therefore the object of the present invention to provide a generic coupling device which requires fewer optical components and allows simple adjustment and focusing of the laser beam so as to avoid energy losses.

This object is accomplished by a generic coupling device having the features set out in claim 1.

Advantageous embodiments are described in the subclaims.

In a coupling device of the invention for feeding a laser beam into at least one optical fiber, a fiber coupler is slideably mounted within said coupling device such that it can be adjusted in height, as well as laterally in the x-y directions, and an optical device has an optical bank including at least two optical components. Said optical bank is connected to said fiber coupler via a coupling element mounted at the end of the optical bank which is opposite the laser beam entry site. The fact that the fiber coupler, and thus the optical fiber as well, can be slid vertically as well as horizontally within said coupling device, and that the optical bank is likewise displaced correspondingly, makes it possible at any time to focus the incoming laser beam on the respective end and/or the surface of the optical fiber. Since the optical components are mounted on the optical bank, any outside influence, especially temperature fluctuations, will not cause the beam to become defocused since any change in length of the optical bank will have a uniform effect on all the optical components mounted thereon alike. In accordance with individual requirements, the optical bank may include the most varied types of optical components. On the other hand, it is possible at any time to reduce the number of optical components.

In an advantageous embodiment of the coupling device of the invention, the fiber coupler is mounted in a recess of the coupling element and firmly connected thereto via one or plural attachment means. This will ensure that any vertical or horizontal adjustment of the fiber coupler with the optical fiber will be identical to that of the coupling element of the optical device and/or the optical bank.

In another advantageous embodiment of the coupling device of the invention, the optical fiber is provided within a fiber plug. The fiber plug surrounding said optical fiber on the one hand serves to protect said optical fiber from dirt and damage, and on the other hand allows said optical fiber to be introduced into said coupling device, in particular said fiber coupler, in a simple and easy manner.

In yet another advantageous embodiment of the invention, the coupling device has a front panel, with said coupling element resting in a recess of said front panel. In this case, the surface area of said recess is larger than the surface area of the coupling element so that—by means of two setscrews mounted in respective internally threaded recesses and contacting said coupling element—said coupling element and said fiber coupler may be slid and positioned in the x-y directions. Turning the setscrews to a certain degree will allow positioning of the coupling element and the fiber coupler in a simple manner, which will in turn ensure optimum focusing of the incoming laser beam on the fiber end of said optical fiber.

In yet another advantageous embodiment of the invention, the sides of said front panel facing said setscrews include respective recesses for accommodating pressure springs. This will ensure that after re-focusing, said coupling element and said fiber coupler can automatically assume corresponding starting positions.

In yet another advantageous embodiment of the coupling device of the invention, a coupling plate is detachably connected to said coupling element by means of at least one attachment means, in such a manner that it will ultimately rest in the area of the front panel between said coupling plate and said coupling element. This makes it possible, once the optical device and/or the coupling element and the fiber coupler have been adjusted and focused, to firmly connect said coupling plate and said coupling element to said front panel via the attachment means such that said elements are fixed to said front panel. Consequently, the adjustment can no longer be changed unintentionally. In order to ensure a respective beam path, said fiber coupler projects into an opening of said coupling plate.

In yet another advantageous embodiment of the invention, a cage for a shutter disk is provided on said coupling plate. Said cage includes an opening which extends in parallel to the axis of the opening of the coupling plate. Said shutter disk, which is gravity-actuated, will close said openings in case no optical fiber or fiber plug has been introduced into said coupling device. This prevents any uncontrolled exiting of a laser beam from the coupling device when no corresponding optical fiber has been introduced into it previously.

In yet another advantageous embodiment of the coupling device of the invention, said optical bank has pin- or rail-like elements for supporting the optical components therein by means of respective support devices. In this case, at least one of said optical components is slideably mounted. The fact that one optical component, i.e. a lens, can be slid horizontally will allow fine-adjustment of the focal point of the incoming laser beam. Any temperature fluctuations will not affect the adjustment since said pin- or rail-like elements are preferably made of steel and thus have a negligibly small coefficient of expansion.

In yet another advantageous embodiment of the invention, the elements of said coupling device are in the form of a module. Such a modular design ensures a simple construction, also allowing a correspondingly easy and simple replacement of individual elements or of the entire module.

Further objects, advantages and features of the present invention may be gathered from the embodiments which follow and which are illustrated in the drawings.

### BRIEF DESCRIPTION OF THE DRAWINGS

FIG. 1 is a simplified front view of the coupling device of the invention;

FIG. 2 is a simplified sectional view taken along line A-A of FIG. 1; and

FIG. 3 is a simplified sectional view taken along line B-B of FIG. 1.

### DESCRIPTION OF THE EMBODIMENTS

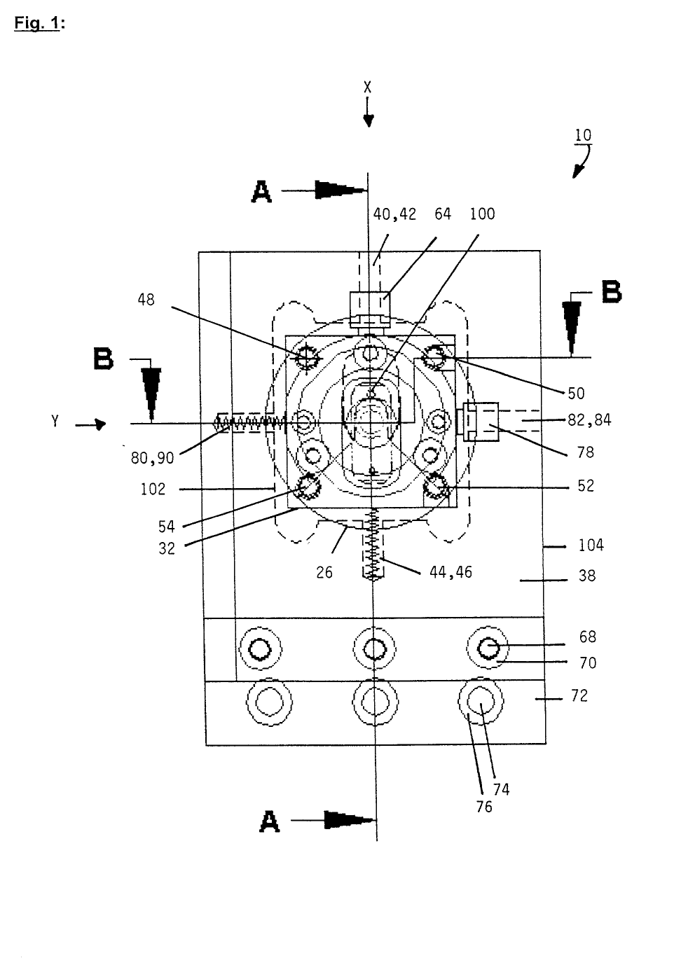

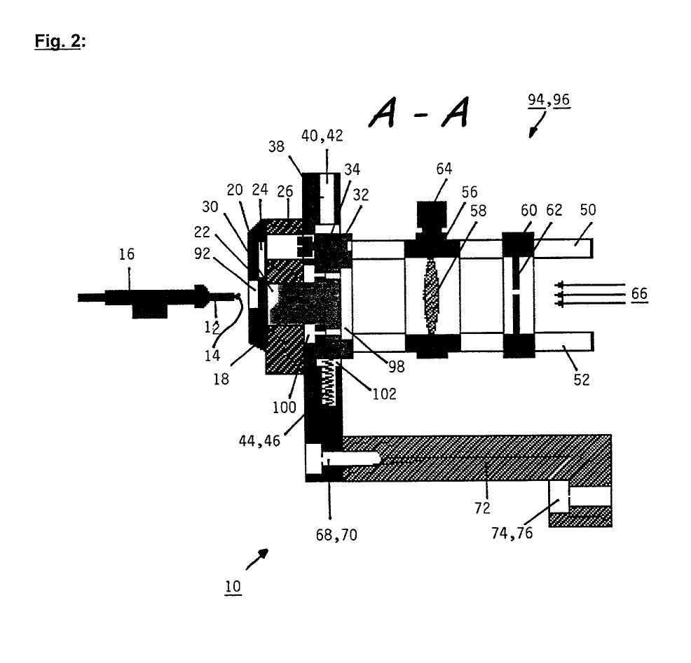

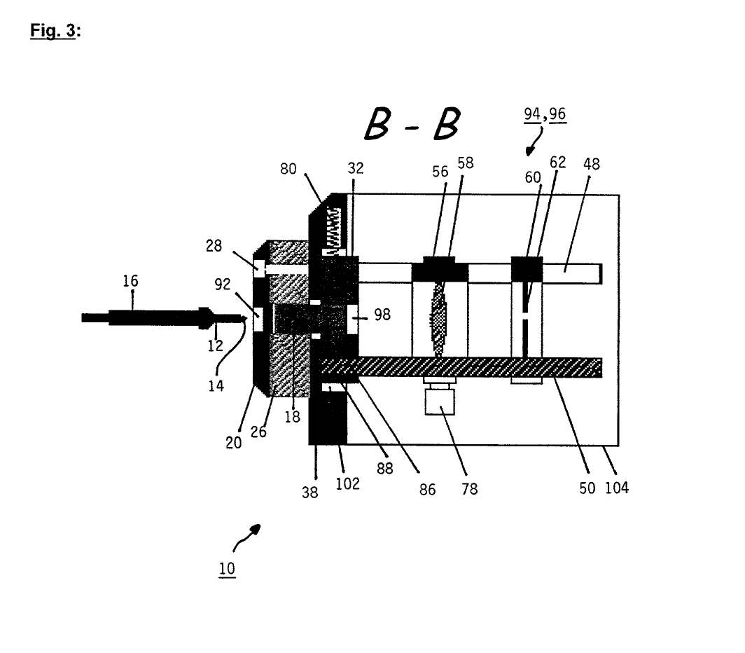

The simplified front view of FIG. 1 shows a coupling device 10 for feeding a laser beam into an optical fiber 12, in particular an optical wave-guide (cf. FIGS. 2 and 3). It can be seen here that said coupling device 10 comprises a casing 104 with a front panel 38. Provided behind said front panel 38 is an angular element 72 which is connected to said front panel 38 via attachment means 68 accommodated within recesses 70. Via attachment means 74 provided within recesses 76 of said angular element 72, said coupling device 10 may for example be connected to a casing of a laser source.

Said coupling device 10 serves especially for introducing pulsed laser radiation of an excimer laser of approximately 10 mJ energy content per pulse and a pulse duration of between 50 and 80 ns. For this, the laser beam power will typically be reduced from 1 MW to approximately 100 kW.

It is furthermore notable from the view of FIG. 1 that said front panel 38 has a recess 102 housing a coupling element 32, with the surface area of said recess 102 being larger than that of said coupling element 32. Said front panel 38 furthermore includes two internally threaded recesses 42, 84, each of which accommodates a setscrew 40, 82. Said setscrews 40, 82 contact said coupling element 32, thus allowing a sliding and positioning, in the x-y directions, of said coupling element 32 and a fiber coupler 18 accommodated within a recess 98 of said coupling element 32 and firmly connected thereto by means of two attachment means 100. Sliding these elements in the x-y directions means that they can be displaced both vertically and horizontally.

The sides of said front panel 38 facing said setscrews 40, 82 include respective recesses 46, 90 for accommodating first and second pressure springs 44, 80. Said springs 44, 80 may each be surrounded by a sleeve (not shown). Said sleeve will protect said pressure springs 44, 80 from becoming bent laterally. Moreover, the total adjustment will be made easier in general.

Finally, it can be seen from the view of FIG. 1 that one actuation means 64, 78 each is mounted in the x- and y-direction, respectively. The embodiment is shown in more detail in the views of FIGS. 2 and 3 which will be described hereinafter.

FIG. 2 for example is a simplified sectional view taken along line A-A of FIG. 1. The view of FIG. 2 shows the coupling device 10 with a fiber coupler 18 for accommodating said fiber 12, and an optical device 94 for deflecting, adjusting and focusing a laser beam 66 on one end 14 of said fiber 12. It can be seen here that said fiber coupler 18 can be slid vertically and horizontally in the x-y directions within said coupling device 10. Said optical device 94 is designed as an optical bank 96 and, in the present embodiment, has two optical components 58, 62, with optical component 58 being a lens and optical component 62 being a diaphragm. Furthermore, said optical bank 96 includes pin- or rail-like elements 48, 50, 52, 54 (cf. also FIG. 1) for supporting therein said optical components 58, 62 via respective support means 56, 60. The first optical component 58, i.e. a lens, is slideably mounted on and along said pin- or rail-like elements 48, 50, 52, 54. Said first optical component 56 can be slid by actuating actuation elements 64, 78. The second optical component 62, i.e. the diaphragm, is mounted stationary in this embodiment. It may be gathered from this view that said laser beam 66 first hits said diaphragm 62 and then said lens 58.

Said optical bank 96 is connected to said fiber coupler 18 via the coupling element 32 provided at the end of said optical bank which is opposite the entry site of said laser beam 66. For this purpose, attachment means 100 are used.

Moreover, it can be seen in this view that a coupling plate 26 is detachably connected to said coupling element 32 via plural attachment means 34. In this case, one region of said front panel 38 will be caused to rest between said coupling plate 26 and said coupling element 32. By tightening the attachment means 34, in particular screws 34, said coupling plate 26 and said coupling element 32 will become fixed to said front panel 38. It is apparent that the fiber coupler 18 projects into one opening 30 of said coupling plate 26.

Mounted on said coupling plate 26 is a cage 20 for a shutter disk 22. Said cage 20 has an opening 92 which extends in parallel to the axis of the opening 30 of said coupling plate 26. Moreover, said cage 20 includes a recess 24 for accommodating said shutter disk 22. Said shutter disk 22 will enter into said recess 24 in case said optical fiber 12—which, in the present embodiment, is mounted within a fiber plug 16—is inserted in said fiber coupler 18. If this is not the case, the shutter disk 22 will close said opening 92, thus preventing any uncontrolled exiting of laser light from said coupling device 10.

The view of FIG. 2 clearly shows the setscrew 40 extending in the x-direction within said recess 42 as well as the respective first pressure spring 44 housed within said recess 46 and exerting a respective counter-pressure to said setscrew 40.

Finally, the view also shows the arrangement of the angular element 72 with the respective attachment means and recesses for said attachment means 68, 70, 74, 76.

FIG. 3 is a simplified sectional view taken along line B-B of FIG. 1. This section extends roughly perpendicularly to the section taken along line A-A. This view additionally shows the attachment of said cage 20 to said coupling plate 26 via said attachment means 28. Furthermore, it shows the second pressure spring 80 extending in the y-direction.

One can see that said coupling element 32 includes openings 88 for accommodating the ends 86 of the pin- or rail-like elements 48, 50, 52, 54.

It becomes clear from the views of FIGS. 2 and 3 that the elements of the coupling device 10 are provided in the form of a module.

Said optical fiber 12 may not only consist of a single optical wave-guide, but it may also take the form of a fiber bunch or any other suitable configuration for the transmission of laser light and laser energy.

As will be understood by one skilled in the art, the invention may be embodied in other specific forms without departing from the spirit and the scope of the invention. The description of the embodiment is given as an illustrative example only and should not be understood as a limitation of the invention which is set forth in the following claims.

What is claimed is:

1. A coupling device for feeding a laser beam into at least one optical fiber, in particular an optical wave-guide, including a fiber coupler for accommodating said fiber, and an optical device for deflecting, adjusting and directing said laser beam towards one end of said fiber wherein said fiber coupler is mounted within said coupling device such that it can be slid vertically and horizontally in the x-y directions, and said optical device includes an optical bank with at least two optical components, said optical bank being connected to said fiber coupler via a coupling element provided at the end of said optical bank opposite the entry site of said laser beam.

2. The coupling device as claimed in claim 1 wherein said fiber coupler is housed within a recess of said coupling element and is firmly connected thereto via one or plural attachment means.

3. The coupling device as claimed in claim 1 or 2 wherein said optical fiber is provided within a fiber plug.

4. The coupling device as claimed in claim 1 wherein said coupling device includes a front panel, with said coupling element resting within a recess of said front panel and with the surface area of said recess being larger than that of said coupling element such that—by means of at least two setscrews mounted in respective internally threaded recesses and contacting said coupling element—said coupling element and said fiber coupler may be slid and positioned in the x-y directions.

5. The coupling device as claimed in claim 4 wherein the sides of said front panel opposite said setscrews include respective recesses for accommodating pressure springs.

6. The coupling device as claimed in claim 1 wherein a coupling plate is detachably connected to said coupling element via at least one attachment means so as to cause one region of said front panel to rest between said coupling plate and said coupling element.

7. The coupling device as claimed in claim 6 wherein said fiber coupler projects into one opening of said coupling plate.

8. The coupling device as claimed in claim 6 wherein a cage for a shutter disk is provided at the coupling plate.

9. The coupling device as claimed in claim 8 wherein said cage includes an opening which extends in parallel to the axis of the opening of said coupling plate.

10. The coupling device as claimed in claim 1 wherein said optical bank includes pin- or rail-like elements for supporting therein said optical components by means of respective support means.

11. The coupling device as claimed in claim 1 wherein at least one of said optical components is slideably mounted.

12. The coupling device as claimed in claim 1 wherein at least one of said optical components is a lens.

13. The coupling device as claimed in claim 1 wherein said optical fiber consists of a fiber bunch.

14. The coupling device as claimed in claim 1 wherein the elements of said coupling device are in the form of a module.
